(19) United States
(12) Patent Application Publication
(10) Pub. No.: US 2026/0318696 A1
(43) Pub. Date: Oct. 15, 2026

(54) METHOD AND SYSTEM FOR DETERMINING AN EMERGENCY ROUTE

(71) Applicant: AUDI AG, Ingolstadt (DE)

(72) Inventors: Vladimir HETZ, Nürnberg (DE); Jan David SCHNEIDER, Cremlingen (DE); Jan Frederik TOTZ, München (DE)

(73) Assignee: AUDI AG, Ingolstadt (DE)

(21) Appl. No.: 19/643,486

(22) Filed: Apr. 9, 2026

(30) Foreign Application Priority Data
Apr. 10, 2025 (DE) 10 2025 114 206.8

(51) Int. Cl. G01C 21/34; B60W 30/18; B60W 60/00; G01C 21/36

(52) U.S. Cl. CPC G01C 21/3461; B60W 30/18163; B60W 60/0015; G01C 21/3415; G01C 21/3492; G01C 21/3658; B60W 2420/403; B60W 2420/408; B60W 2552/53; B60W 2554/4042; B60W 2554/4044; B60W 2554/406; B60W 2556/40

(57) ABSTRACT

The disclosure relates to a method and system for determining an emergency route for an automated driving function of a vehicle. The method may comprise a plurality of method steps. In a first method step, map information associated with infrastructure features of drivable lanes of a road to be traveled may be acquired. Furthermore, attributes for the drivable lanes may be determined based on the acquired map information. Furthermore, an emergency route may be determined based on the determined attributes of the drivable lanes.

### TECHNICAL FIELD

The present disclosure relates to a method and a system for determining an emergency route for an automated driving function of a vehicle. Furthermore, a vehicle having the system according to the disclosure is provided. Additionally or alternatively, a computer program is provided that comprises commands which, when the program is executed by a computer, cause it to at least partially execute the method.

### BACKGROUND

Society of Automotive Engineers (SAE) Level 3 automated driving systems take over vehicle control independently within their defined operating conditions. If the driving system reaches the limits of these operating conditions or a critical situation occurs, a transition demand (TD) may be triggered, prompting the driver to take control of the vehicle. If the driver does not react, a minimal risk maneuver (MRM) may be initiated, which aims to bring the vehicle safely to a stop.

According to regulatory requirements, such as United Nations Economic Com-mission for Europe (UNECE) R157, an MRM can be carried out on different lanes or in a defined stopping region, e.g., on a breakdown lane, a shoulder, or in the slowest traffic lane. International standards, such as ISO 23739:2024, specify that the MRM must also be activated in the event of serious faults in the automated driving system or the vehicle.

### BRIEF DESCRIPTION OF THE DRAWINGS/FIGURES

FIG. 1 schematically shows a motor vehicle in a road portion to be traveled while carrying out an embodiment of the method according to the disclosure.

FIG. 2 schematically shows a motor vehicle having a system, according to some embodiments.

FIG. 3 schematically shows a flowchart of a method, according to some embodiments.

### DETAILED DESCRIPTION

Existing driving systems for performing an MRM often use rule-based decision logics or static decision trees that determine whether the vehicle stops within the current lane or changes lanes to reach a safer stopping position. However, these decision logics are rigid and do not take into account all dynamic influencing factors, such as the current traffic situation and the possibility of carrying out a safe lane change, the road infrastructure, including the availability and quality of breakdown lanes or parking areas, and/or the behavior of other road users, which may affect the safety of a stopping maneuver.

Another problem can be that existing systems calculate the emergency route only after the TD has elapsed, resulting in a loss of valuable time and potentially suboptimal selection of stopping positions. Furthermore, the severity of a system fault is not adequately taken into account, so the vehicle does not always find an optimal balance between rapid risk minimization and a safe parking position.

Furthermore, the currently available systems for conducting an MRM have multiple limitations relating to the lack of dynamic consideration of the traffic situation. Existing systems do not assess in real time whether a lane change is useful or necessary, but make decisions based upon a static set of rules. Furthermore, there may be a limited selection of safe stopping positions, so the systems are often restricted to either stopping in the current lane or performing a predefined lane change without a comprehensive evaluation of the best available stopping options. Furthermore, no early calculation of the emergency route is provided. Current methods often calculate the optimal stopping point only after the TD has elapsed, instead of developing early on a strategy for the best possible stopping position.

The object of the present disclosure is to specify a method and/or a system that are each suitable for enhancing the downfalls of the conventional systems.

The object may be achieved, according to a first aspect, by a method for determining an emergency route for an automated driving function of a vehicle. The method may involve a plurality of method steps.

The emergency route, as defined in the present disclosure, can specify an optimal stopping point and/or one or more trajectories. Furthermore, the emergency route can contain a sequence of trajectories, and/or the trajectories can be planned along the route. Furthermore, the emergency route can be understood as a dynamically calculated trajectory that leads the vehicle to a safe stopping position along an optimized route as part of a minimal risk maneuver (MRM) or a comparable emergency strategy. The emergency route is based upon a continuous analysis of static map information, infrastructure conditions, and, alternatively, real-time traffic data, and enables adaptive control of the vehicle taking into account the current environmental conditions. The emergency route may be calculated by weighting various influencing factors to ensure the best possible balance between safety, availability, and feasibility of a stopping operation. This can take into account both static attributes, such as the number and type of lanes, breakdown lane availability, or structural separations, as well as dynamic parameters, such as current traffic density, speed of adjacent vehicles, time gaps for lane changes, or temporary closures. Processing this information allows for a precise determination of the optimal driving line, so that the vehicle can be brought to a standstill with minimal risk. Various algorithms can be used for the technical implementation of the emergency route, including route-optimizing methods that calculate the shortest, safest, and most energy-efficient route possible, as well as predictive models that anticipate future traffic developments based upon historical and current sensor data. Additionally, fleet data can be used to incorporate already-validated stopping points of other vehicles into the calculation and to increase the probability of a successful MRM.

In some embodiments, in the first step, there takes place an acquisition of map information with infrastructure features of drivable lanes of a road portion to be traveled. To determine an emergency route, map information may be first acquired, including infrastructure features of the road portion and the drivable lanes. This information can contain the number of lanes, their width, the location of breakdown lanes, lane markings, and other relevant features essential for the safe navigation of a vehicle. This step makes it possible to create a basis for the later assessment of the safety situation by using statistical information that is already available in advance. This may speed up the calculation of the emergency route, since the system is not solely reliant on real-time sensor data. In the sense of the present disclosure, a drivable lane can be understood as a lane on a road portion defined by infrastructure and traffic-related conditions, which lane is suitable for regular or temporary use by a vehicle. The drivability of a lane can be influenced by both static features, such as road geometry and markings, and dynamic factors, such as traffic conditions or temporary closures.

In a further step, attributes for the drivable lanes may be determined based upon the acquired map information. Based upon the acquired map information, lanes may be given specific attributes. These attributes represent features such as lane type, permissible speed, gradient, curvature, and, where applicable, risk-based factors that can be derived from past experience and/or fleet data. By assigning attributes, lanes are not only described in terms of infrastructure, but are also classified as to their suitability for a potential minimal risk maneuver (MRM). This improves the decision-making, since a structural assessment of the environment takes place even before an acute emergency situation arises.

The classification of lanes is used to assess their suitability for a minimal risk maneuver (MRM) and enables a differentiated evaluation of road portions with regard to their safety as potential stopping positions. The classification is carried out by assigning attributes that can take into account both static and dynamic factors in order to enable a precise assessment of the road infrastructure and the current traffic situation. The lanes can be categorized using a numerical scale or qualitative rating, wherein lower values or more favorable ratings represent safe stopping zones, while higher values or unfavorable ratings may indicate increased danger and poorer suitability. A possible rating could range from primary stopping areas, such as breakdown lanes or emergency bays, to secondary stopping areas, such as right-hand lanes with moderate traffic flow, to areas that are to be avoided, such as left-hand passing lanes and/or lanes without safe evasion options.

The classification can be based upon a combination of predefined static attributes and dynamic real-time data. Static attributes may be based upon high-resolution map information that captures infrastructure features such as the number of lanes, the availability and width of breakdown lanes, the existence of emergency bays or other stopping zones, and the visibility of the stopping area to other road users. Furthermore, national traffic regulations, such as the requirement to drive on the right and/or special usage regulations for breakdown lanes, can be taken into account in the assessment. Dynamic attributes can complement this classification by acquiring current traffic data, including traffic density, the relative speed of adjacent lanes, available time gaps for lane changes, temporary obstacles such as construction sites or accidents, and weather conditions that may affect road conditions.

In addition to combining static and dynamic factors, the integration of fleet data can be considered in the continuous adaptation of the classification. Historical data from other vehicles can be used to assess the suitability of a particular area as a stopping position with a probability of success. If a portion of road has proven to be a safe stopping area in the past, it can be given preferential classification, while areas where problems have repeatedly occurred can be downgraded. The use of fleet data thus enables a trainable adaptation of the classification, which is further optimized with each MRM situation carried out.

Early classification of lanes ensures that the system can identify and assess potential stopping areas before an emergency occurs, instead of having to determine a suitable position when an acute MRM situation is already happening. This enables faster and safer decision-making, since the vehicle already has a list of potential stopping zones that can be compared with current traffic data in real time. This allows for continuous reassessment and situation-specific adaptation of the emergency route.

Furthermore, the ascertainment of an emergency route is provided based upon the specific attributes of the drivable lanes and the acquired traffic data. Based upon the adapted lane attributes and current traffic data, an emergency route is determined that describes the optimal movement of the vehicle to minimize the risk during an MRM. This emergency route takes into account both the best available stopping position and the possibilities of reaching a safe lane.

This ensures that the vehicle does not just make a static decision, but adapts the optimal stopping point in real time. This differs significantly from deterministic systems, which rely on fixed decision logics and cannot react flexibly to changing conditions.

The method offers a number of advantages. Among other things, the proposed method enables a precise and efficient determination of an emergency route for an automated driving function by acquiring map information with infrastructure features of a road portion and deriving attributes for the individual lanes therefrom. By additionally acquiring current traffic data, it can be ensured that the attributes of the lanes are not only based upon static information, but can also be adapted to the particular traffic situation. This allows for a situation-dependent assessment of the lanes regarding their suitability for safe stopping, thereby enabling a targeted selection of an optimal stopping position. In contrast to conventional methods, which are often based upon predefined decision trees or rigid rules, this method allows for a flexible and dynamic ascertainment of the emergency route that takes current conditions into account. This allows the vehicle to develop and adapt a strategy for a minimal risk maneuver early on, thereby improving the safety of the vehicle occupants and other road users.

Furthermore, through map-based evaluation and categorization in advance of road portions, the method enables a priori calculation, which provides an assessment of potential corridors for safe stopping even before the actual driving decision. These corridors serve as the basis for emergency route planning, meaning that all possible options do not have to be calculated in real time; rather, a predefined, optimized database can be used. The combination of this static advance information with environmental and traffic data acquired live enables a decision-making process that takes into account both the theoretical suitability of a stopping point and the current traffic situation. This ensures that previously calculated stopping zones are usable in the particular situation and can be dynamically adapted if necessary.

In contrast to deterministic, rule-based approaches that rely on fixed decision trees and define a predetermined response for each fault scenario, the method according to the disclosure allows for an adaptive and flexible response to unforeseen events. While existing systems evaluate a situation, e.g., using a fault matrix, and may have critical limitations if a particular course of action is excluded due to a single criterion, the method disclosed herein offers a holistic assessment of all available options for action. For example, an obstacle such as a pothole can not only be viewed as a static restriction that makes a certain route impossible, but can be dynamically assessed depending upon traffic density, position, size, and possible alternative routes within the emergency route. As a result, the system remains flexible in different situations, is able to identify a more optimal route with minimal risk, and prevents meaningful options from being overlooked due to rigid decision logics.

In addition, the method according to the disclosure reduces the computational effort required, since the combination of static priori data and dynamic real-time information means that not all potential stopping areas have to be calculated, laboriously, in real time. Rather, potential corridors are categorized even before the actual calculation of the emergency route, so that only the most relevant alternatives are included in the real-time analysis. This leads to faster and more efficient decision-making, especially in critical situations where a delayed response could increase the risk of an accident.

The methods can be computer-implemented methods, i.e., one, a plurality, or all steps of the methods can be carried out at least partially by a computer or a data processing device, optionally a control device, in particular a processing unit or control device of the system according to the disclosure. Where appropriate, it can be provided to carry out the steps in a different order than described.

Possible further developments of the aspects of the disclosure described above are explained in detail below. Each of the following developments can further develop and make concrete the methods described above, both separately and in combination.

It can be provided that, in a further step, traffic data may be acquired for the road portion to be traveled. In addition to the static map information, traffic data may be acquired in real time. The traffic data may comprise the current vehicle position, traffic density, relative speeds on the lanes, time gaps for potential lane changes, and the detection of obstacles or other relevant changes in road conditions. The acquisition of this data allows the static evaluation to be supplemented by a dynamic component, enabling the system to make situation-adaptive decisions. While existing systems often rely only on static decision trees or predefined maneuvers, this step allows individual adaptation of the emergency route to the current traffic situation.

Furthermore, it can be provided that the attributes for the drivable lanes be adapted depending upon the acquired traffic data. The specific attributes of the lanes can be updated based upon current traffic data. For example, a lane that is considered a potential stopping area based upon static information can be identified as unsuitable in real time if there is high traffic density or a temporary construction site there. This step means that the evaluation of stopping positions is based not only upon predefined parameters, but upon a continuous analysis of the traffic situation. This prevents an MRM from directing the vehicle to a supposedly safe position that becomes unsuitable due to temporary changes.

It can be provided that an emergency route escape vector be ascertained based upon the specific attributes of the drivable lanes and the acquired traffic data.

It can be provided that the method may comprise continuous real-time adaptation of the emergency route during a transition demand (TD) and/or a minimal risk maneuver (MRM). The implementation of this function may have the result that the emergency route is not determined only once, but can be adapted to changing conditions throughout the entire process. This ensures that the vehicle can react to new traffic situations, in particular if potential stopping positions change or dynamic obstacles arise.

It can be provided that the method in addition may comprise the provision of control instructions for controlling the vehicle based upon the ascertained emergency route. The inclusion of this function allows the calculated optimal maneuvers to be directly passed on to the vehicle system and implemented, thus ensuring more precise and safer control of the vehicle in an MRM. Control instructions, in the sense of the present disclosure, can be understood as electronic commands generated by a vehicle's control system and forwarded to the relevant vehicle systems to influence vehicle movements or other driving dynamic states in a targeted manner.

These commands can be calculated based upon sensor data, map information, predefined control algorithms, and/or real-time traffic data to enable precise and safe vehicle control. In the context of an autonomously controlled vehicle, control instructions may comprise commands for the longitudinal and lateral guidance of the vehicle. Longitudinal control relates to the control of the speed by adapting the engine power or braking force, while lateral control comprises influencing the steering angle to guide the vehicle along a specific trajectory. The calculation of the control instructions may be carried out by a central processing unit that continuously evaluates environmental conditions and internal vehicle systems in order to make optimal maneuvering decisions.

It can be provided that the attributes of the adjacent lanes be adapted depending upon a detected fault severity, and that the fault severity be assigned to a predefined class from a plurality of fault classes. The adaptation of the lane attributes can affect both the weighting of existing risk assessments and the selection or prioritization of specific lanes in the emergency route.

This has the technical effect that the selection and evaluation of lanes is not done in a static manner or solely dependent upon traffic, but also in the context of the specific technical system state of the vehicle. This allows the system behavior to become significantly more robust against fault conditions having different levels of severity, since targeted risk-reducing measures can be taken in route planning depending upon the type and severity of the detected fault. Including the severity of the fault in the attribute assignment makes it possible to bring the vehicle into a defined safety state at an early stage while specifically excluding or preferentially taking into account lanes that appear suitable or unsuitable for the particular fault class.

In the sense of the present disclosure, the severity of the fault can be understood as a technical measure value that describes the functional impairment of the automated vehicle quantitatively or qualitatively. It can be caused, for example, by the loss of individual sensor functions, by limited braking or steering systems, or by communication failures. The severity of the fault can be assessed continuously or in steps-for example, using predefined system diagnostic parameters.

A predefined class can be understood as a structured entry in a category system, to which a specific range of fault severity values or fault types is assigned. Each class represents a specific category of risks associated with the detected fault situation and can be linked to specific reactions in the emergency route algorithm.

The multiplicity of fault classes can represent a hierarchically or logically organized classification system that distinguishes between different types of technical malfunctions. These fault classes can be categorized, for example, into levels such as “slight,” “moderate,” “critical,” or into functionally defined classes such as “sensor failure,” “actuator limitation,” or “communications interruption.” Each of these classes can be linked to specific action patterns for attribute assignment and emergency route calculation in order to enable targeted, state-dependent risk minimization.

It can be provided that the emergency route be continuously adapted in real time, taking into account the remaining travel time until the MRM is reached. The inclusion of this function enables predictive route planning, so that the remaining time can be used optimally to brake the vehicle into the safest possible position and/or to change lanes and/or to bring the vehicle to a standstill. This allows the vehicle to react early to the need for an MRM and enables more precise control in order to minimize risk.

It can be provided that the control instruction comprises a lane change if the traffic data identify a lane of the drivable lanes of the road portion to be traveled that has a lower risk value than the currently traveled lane. This allows the vehicle to actively seek a safe lane instead of remaining static in its current lane, resulting in better adaptation to the traffic situation. A risk score can be understood as a numerical assessment of the risk posed by a lane or driving strategy in relation to the safety of an automated vehicle. The risk value is determined through a combination of static infrastructure data and dynamic traffic data, which are analyzed in real time.

Static factors comprise, for example, lane features such as the presence of a breakdown lane, road curvature, lane width, and visibility conditions, while dynamic factors comprise current traffic density, the speeds of adjacent vehicles, available time gaps for lane changes, and temporary obstacles such as construction sites. The risk value can be represented in a scaled rating system, e.g., from 0 to 10 or from 0 to 100, wherein a low value indicates a low risk and a high value indicates an increased danger. Weighted algorithms are used for the calculation, taking different parameters into account with different strengths depending upon the specific traffic situation. This weighting can adapt dynamically-for example, if the traffic situation changes or a system fault influences the sensor data. In addition, historical fleet data and machine learning can be used to assign a high risk value to known dangerous lanes at an early stage. The calculated risk value is continuously updated and serves as a basis for decisions regarding driving maneuvers, including lane changes, braking strategies, and the choice of stopping position. By using an adaptive risk value, the vehicle can react flexibly to changing conditions and implement a safe, optimized driving strategy by always choosing the best available route with the lowest potential risk.

It can also be provided that the control instruction comprises a braking strategy to decelerate the vehicle in a zone rated as safe within the calculated emergency route. This function can help ensure that the vehicle does not stop abruptly or in unsuitable places, but instead selects in a targeted manner an optimized stopping position within the available infrastructure.

The rated zone within the calculated emergency route designates a specific region along the calculated trajectory of a vehicle, which has been assessed based upon static and dynamic factors with regard to its safety and suitability for a minimal risk maneuver (MRM). This rating may be achieved through a weighted analysis of infrastructure data, traffic conditions, and historical fleet data, whereby each portion of the emergency route is assigned a risk value in order to determine an optimal stopping position. The rated zone is a prioritized stopping area, enabling the vehicle to ensure a safe, rule-compliant, and/or efficient and/or controlled stop.

It can be provided that the attributes of the lanes be determined based upon a risk assessment which is ascertained by a combination of infrastructure features and traffic data. This allows for an objective assessment of the lanes with regard to their suitability as stopping positions, ensuring that both static and dynamic factors are taken into account in the decision-making process.

It can be provided that the adaptation of the attributes for the lanes comprise an assessment of safety risks based upon a calculated risk value in order to determine a stopping position within the emergency route. This function can contribute to a more precise prioritization of potential stopping zones by not only considering individual attributes, but carrying out a holistic risk assessment of the relevant portion.

It can be provided that the acquired traffic data comprise the current position of the vehicle. This allows the emergency route to be precisely adapted to the site conditions.

It can also be provided that the acquired traffic data comprise the traffic density on the individual lanes. This function helps the system identify lower-risk areas in order to perform the MRM more safely. This can increase the safety of the maneuver.

It can also be provided that the acquired traffic data comprise the available time gaps for lane changes. This allows the system to recognize whether a lane change can be carried out safely or whether alternative stopping positions should be considered.

It can also be provided that the acquired traffic data comprise the speed and/or direction of movement of adjacent vehicles. This allows for a more precise risk analysis in order to optimize the MRM taking into account the current traffic dynamics.

It can be provided that, when ascertaining the emergency route, a weighting be applied between static and dynamic attributes depending upon the type and severity of a detected fault in the vehicle. This allows for the targeted prioritization of the decision parameters that are optimal for the particular fault situation. In the sense of the present disclosure, a fault can be understood as a detected technical or functional defect within the automated driving function of the vehicle that impairs the regular control or driving behavior and necessitates an adaptation of the emergency route. Such a fault can be divided into different categories that relate to both vehicle hardware and software-based control systems.

System faults can be divided into different categories that affect different components and functions of the vehicle. A significant group can be sensor faults, which can lead to a failure or impairment of camera, LIDAR, or radar systems, thereby severely limiting environmental detection. Similarly, delayed or faulty data fusion between multiple sensor channels can lead to the system receiving incorrect or inaccurate environmental information. Another problem in this category is the failure and/or inaccuracy of GPS signals, resulting in incorrect position de-terminations, which can be problematic in particular for navigation and emergency route calculation.

Another category of faults are actuator faults, which directly impair vehicle control. These may include malfunctions of the steering, brakes, or drive system that can lead to a complete or partial restriction of vehicle control. Particularly critical are faulty or delayed braking reactions that cause the vehicle to brake unexpectedly or to not be brought to a stop in time.

Communication faults are also safety-relevant, since they disrupt internal or external data transmission in the vehicle. A failure or interruption of the controller area network (CAN) bus system can cause control units to no longer communicate properly with each other, which directly affects safety-critical functions such as braking or steering commands. Similarly, a malfunction of the vehicle to everything (V2X) communication can lead to the vehicle no longer receiving current environmental information, so that essential information is not taken into account, such as construction site warnings or traffic data.

To ensure the best possible response to a detected system fault, an adaptive weighting between static and dynamic attributes is performed when ascertaining the emergency route. This weighting can ensure that different decision priorities are set depending upon the type of fault in order to bring the vehicle to a stop as safely as possible.

In the event of a sensor failure, the system can rely to a greater extent on static map information and fleet data to compensate for the missing or inaccurate sensor data. Since environmental perception can be impaired by faulty or failed sensors, the vehicle will increasingly rely on existing high-resolution map information and historical traffic data from other vehicles to reliably identify potential stopping zones. In the event of an actuator failure, in contrast, the system can prioritize reaching a safe stopping position by considering alternative braking or control strategies early on. In this case, the system could for example choose a gentle braking strategy to enable the least risky deceleration possible, or specifically search for lanes with low traffic density to ensure a safe stop. If a communication fault occurs, the vehicle could make redundant decisions-for example, by giving more weight to local sensor data and ignoring external traffic data. This ensures that the vehicle remains able to independently calculate an escape strategy, even if no current information about the traffic situation or infrastructure is available from external sources.

The weighting between static and dynamic information is also done depending upon the fault priority. A minor fault, such as a temporary sensor malfunction, can cause the system to continue taking dynamic traffic conditions into account in order to choose an optimal driving strategy. The vehicle remains able to process real-time data in order to react flexibly to the current traffic situation. Conversely, a critical fault, such as a total failure of the steering or brakes, could cause the vehicle to prioritize only available static stopping zones in order to minimize the risk of uncontrolled movement. In such a case, any dynamic adaptation is overridden in favor of an immediate, safe stopping position, so that the vehicle is brought into a safe state as quickly as possible.

It can be provided that traffic data from the vehicle's surroundings, including camera data, radar data, and/or LIDAR data, be used for the continuous adaptation of the emergency route. This makes it possible to provide a highly accurate environmental analysis, which provides an improved risk assessment for the MRM.

It can be provided that the map information comprises the number of lanes. This allows for a basic infrastructure categorization to determine which options are available for changing lanes and/or a stopping position.

It can also be provided that the map information comprises the type of lanes. This allows for differentiation between different road segments, such as main lanes, acceleration lanes, and breakdown lanes, in order to determine a suitable strategy for carrying out an MRM.

It can also be provided that the map information comprises the availability of breakdown lanes. This ensures that the system has suitable emergency areas available to bring the vehicle to a stop in a safe position in a controlled manner.

It can also be provided that the map information comprises the position of the breakdown lanes. The inclusion of this function makes it possible to specifically check during emergency route calculation whether a breakdown lane is within a reachable distance and is suitable as a stopping position.

It can also be provided that the map information comprises lane markings. This helps to make it possible to identify whether lane changes are possible or whether there are re-strictions due to solid lines that could limit a maneuvering option.

It can also be provided that the map information comprises traffic signs. This allows the system to receive additional information about speed limits and/or special traffic regulations that could affect the MRM.

It can also be provided that the map information comprises a traffic guidance system. This function helps to inform the system about existing traffic management systems that announce, for example, temporary road changes and/or construction sites and/or other current traffic changes, thereby increasing the accuracy of the emergency route calculation.

It can be provided that the map information be updated at intervals using fleet data. This ensures that the system always works with up-to-date information and is not solely reliant on static map data.

It can be provided that the lane attributes comprise at least one value for an average speed on the relevant lane. This allows the relative dynamics of road users to be analyzed and a decision to be made as to whether a lane change makes sense in order to reduce the risk.

It can also be provided that the attributes of the lanes be updated in real time, taking into account temporary changes in the infrastructure, including construction sites, accidents, and/or weather conditions. The inclusion of this function makes it possible to react to unexpected road conditions and to develop an adaptive strategy for minimizing risk.

It can be provided that the emergency route be determined in such a way that the vehicle reaches a safe stopping position within a defined time window. This ensures that the vehicle is not exposed to an increased risk for an unnecessarily long time and can complete a safe maneuver within the given time.

Furthermore, according to another aspect of the disclosure, the object is achieved by a system for determining an emergency route for an automated driving function of a vehicle (motor vehicle). The system is used to ascertain an emergency route for an automated driving function of a vehicle. The vehicle's surrounding environment is acquired, and a dynamic adaptation of the emergency route is carried out based upon map and traffic data. This enables precise and adaptive control of the vehicle in situations where a minimal risk maneuver (MRM) is required.

The system may comprise a first acquisition unit that is designed to acquire map information with infrastructure features of drivable lanes of a road portion to be traveled. The first acquisition unit may be designed to acquire map information that contains relevant infrastructure features of the road portion and the lanes. This may include parameters such as the number and type of lanes, the presence of breakdown lanes, road markings, national traffic regulations, and specific road characteristics such as curvature or gradient. The first acquisition unit can be technically designed to retrieve stored map information either directly from an internal vehicle memory and/or to obtain updated map data via an external cloud connection.

If the map information is stored in the vehicle's memory, the system can comprise a local storage unit containing high-resolution map information. This storage unit can, for example, be a solid-state drive (SSD), a flash memory card, and/or a dedicated storage partition within the system. The advantage of this solution is its low latency when retrieving map information, since no external data transmission is required. The stored maps can be regularly updated via over-the-air (OTA) updates, so that new infrastructure changes such as construction sites or altered traffic patterns are taken into account.

If the map information can be retrieved via the cloud, the first acquisition unit can be equipped with a wireless communications interface that enables a connection to a cloud-based map server. This can be done via LTE, 5G, or dedicated V2X communication. In this case, the system may retrieve updated map information as needed in order to always use the latest road infrastructure data. Cloud connectivity enables continuous map updating, allowing dynamic changes such as temporary road closures or new traffic patterns to be incorporated into the calculations almost in real time.

To improve redundancy, the first acquisition unit can combine both methods by first accessing locally stored map information and then validating or supplementing it with a cloud query. If no cloud connection is available, the system can continue to use the last-saved map information and retrieve updated data after the network connection is restored. Additionally, the first acquisition unit can be combined with sensor fusion techniques, so that detected infrastructure features from camera, LIDAR, or radar systems can be compared with the stored map information. This allows inaccuracies or outdated map data to be validated by the vehicle's current environmental acquisition.

Furthermore, a processing unit is provided. The processing unit can be realized as a component of the vehicle, either within the vehicle itself or on an external server. The processing unit can be designed as a control device for the motor vehicle. The control device can be part of a driver assistance system of the motor vehicle or constitute the system itself. The processing unit or control device can, for example, be an electronic control unit (ECU). The electronic control unit can be an intelligent processor-controlled unit that can communicate with other modules via a central gateway (CGW) and can, if appropriate, form the vehicle electrical network via fieldbuses such as the CAN bus, LIN bus, MOST bus, FlexRay, and/or Automotive Ethernet, e.g., together with telematics control units and/or actuators and/or environmental sensors. Corresponding interfaces can be designed for this purpose. It is conceivable that the control device control functions relevant to the driving behavior of the motor vehicle, such as the steering, engine control, power transmission, and/or the braking system. Furthermore, driver assistance systems, such as a parking assistant, adaptive cruise control (ACC), lane keeping assistant, lane change assistant, traffic sign recognition, light signal recognition, hill start assist, night vision assistant and/or intersection assistant, or the entertainment system, can be controlled by the control device.

The processing unit may be designed to determine attributes for drivable lanes based upon the acquired map information. The processing unit analyzes the acquired map information and determines attributes for the individual lanes therefrom. These attributes comprise, for example, the permitted speed in a lane, the visibility to other road users, or the proximity to emergency bays or breakdown lanes. Determining these attributes allows for a qualitative assessment of each lane, enabling the system to make a differentiated assessment of the suitability of a lane as a potential stopping zone. This early classification helps ensure that, in the case of an MRM, a suitable stopping position does not have to be first searched for in real time; rather, a pre-evaluated selection is already available.

Furthermore, the processing unit may be designed to ascertain an emergency route based upon the determined attributes of the drivable lanes. The processing unit may calculate the emergency route based upon the adapted lane attributes and the current traffic data. This route describes the optimal movement of the vehicle in order to minimize the risk during an MRM. This may involve carrying out a weighting between static and dynamic factors to make the best possible decision for a safe stopping position. By calculating the emergency route, the vehicle can not only determine a suitable stopping position, but can also plan the movement to reach it. For example, the system can analyze whether a lane change is necessary to reach a safer area, or whether braking within the current lane is the better option.

In one embodiment of the system, a second acquisition unit can be provided which is designed to acquire traffic data for the road portion to be traveled. The second acquisition unit is used for the real-time acquisition of traffic data for the portion of road on which the vehicle is moving. This data may include parameters such as traffic density, average speeds on the individual lanes, available time gaps for lane changes, and data on the direction of movement of adjacent vehicles. By continuously acquiring this data, the system can perform a dynamic risk assessment of the environment. This enables an adaptive response to sudden changes in the traffic situation, such as traffic jams, accidents, or construction sites. The combination of traffic data with static map information ensures that the system can react flexibly to changing conditions by developing an optimal strategy for adapting the emergency route. The second acquisition unit can comprise cameras, lidar, and/or radar systems and/or further sensors for acquiring environmental data.

For this purpose, the processing unit may be further designed to adapt attributes for the drivable lanes depending upon the acquired traffic data. The processing unit adapts the previously determined lane attributes depending upon the acquired traffic data. For example, a lane that was rated as safe based upon the map information may be recognized as unsuitable due to temporary factors such as high traffic density or construction sites. This dynamic adaptation of lane attributes may ensure that the system always works with up-to-date information and calibrates its decisions to the current traffic situation. This may prevent the vehicle from selecting a stopping area that was originally safe but is unsuitable in the current situation. For this purpose, the processing unit is designed to determine an emergency route based upon the determined attributes of the drivable lanes and the acquired traffic data.

The disclosure also includes developments of the system described above, which has features already described in connection with the developments of the method according to the disclosure. For this reason, the corresponding developments of the method according to the disclosure are not described again here, and what has been described above with reference to the method also applies analogously to the system, and vice versa.

What has been described above can be summarized in other words and in a possibly more concrete realization of the disclosure as described in the following, wherein the following description is not to be interpreted as restrictive for the disclosure.

It can be provided that the map information (map data) be stored and validated for changes and to stay up-to-date for the vehicle fleet, if possible. According to the disclosure, the stored map data may be categorized. The categorization is a static risk assessment that results from the infrastructure conditions. Examples include (but are not limited to) the number and type of lanes, the position of the lanes, road markings, the presence of a breakdown lane, the position and number of breakdown lanes, the visibility of the location point by other road users, and national traffic regulations (e.g., the requirement to drive on the right).

A static classification may be carried out using factors such as the number of adjacent lanes and the average speeds driven on each of the lanes; other factors such as the curvature or inclination of the road can also be decisive.

In addition to the static risk assessment, a dynamic risk assessment may also be carried out. The dynamic risk assessment ascertains factors such as the current position of the home vehicle on the road, the current traffic situation, the possibilities (affected by time gaps and road markings) for changing lanes, as well as the possibility of reaching lanes with a static risk assessment that is more positive (than the currently occupied lane) under the given dynamic conditions. This allows the formation of an emergency route to take place already during the transition demand (TD). Furthermore, the temporal and spatial change in the vehicle's position can influence the orientation of the emergency route. Furthermore, the severity of the fault can be taken into account here, possibly by a previously defined (using data) expected range of the system in the presence of the given fault or the severity of a specific fault.

Any interaction between the driver and the vehicle, such as a possible oversteering or takeover, can affect the orientation. In certain situations, the emergency route may coincide with the vehicle's direction of travel; in these cases, the static risk assessment can be used to form a judgment about the best possible stopping position along the lane. The weighting of static and dynamic information can be determined depending upon the fault and its severity. Furthermore, it can be possible to integrate the static risk assessment directly into the map of the driving function. This allows a risk score (risk value) for stopping points to be directly assigned to certain lane segments. It can be provided that fleet data be integrated into both static and dynamic risk assessments. Furthermore, the fleet data can be assigned a probability of success, provided that other vehicles (under the presence of certain faults) have already calculated an emergency route and executed an MRM. Such data can be included in the calculation of the static risk assessment, as, among other things, a score/weighting.

This can result in a significant improvement in the calculation of safe stopping points, and thus a significant reduction in the residual risk for the driver, in particular in cases where it may be necessary to exit the vehicle. There can be the possibility of (quick) integration of static data (as well as low computational costs) and integration of dynamic data, possibly depending upon the fault; however, there is no necessity to calculate stopping points using static data when triggering the MRM. It is possible to integrate physical conditions into the calculation of stopping points.

The technical implementation takes place as part of the automated driving function or, if appropriate, as a separate function that interacts with the automated function.

In addition, a vehicle equipped with the system described above will be provided. The vehicle (motor vehicle) can be a passenger car, in particular an automobile, or a commercial vehicle, such as a truck. The motor vehicle can be a level 3 autonomous vehicle, i.e., condition-ally automated to an extent that the driver does not have to continuously monitor the vehicle system. The motor vehicle may independently perform functions such as activating the turn signal, changing lanes, and/or staying in the lane. The driver can engage in other activities, but will be prompted by the system to take over driving duties within an advance warning period if necessary. The motor vehicle can be a level 4 autonomous vehicle, i.e., so highly automated that the vehicle control is permanently taken over by the vehicle's system. If the system can no longer handle the driving tasks, the driver may be prompted to take over driving. The motor vehicle can be a level 5 autonomous vehicle, i.e., so fully automated that the driver is not required to perform the driving task. Apart from setting the target and starting the system, no human intervention is required. The motor vehicle can function without a steering wheel and pedals. What has been described above with reference to the method and the system also applies analogously to the motor vehicle, and vice versa.

Furthermore, a computer program is provided comprising commands that, when executed by a computer, cause this computer to at least partially execute the methods described above. The program code of the computer program can be in any type of code, in particular in a code suitable for control devices of motor vehicles. What has been described above with reference to the system, the vehicle, and the method also applies analogously to the computer program, and vice versa.

Furthermore, a computer-readable medium, in particular a computer-readable storage medium, will be provided. The computer-readable medium comprises commands that, when executed by a computer, cause this computer to at least partially execute the methods described above. That is, a computer-readable medium can be provided that comprises a computer program as defined above. The computer-readable medium can be any digital data storage device, such as a USB stick, a hard drive, a CD-ROM, an SD card, or an SSD card (or SSD drive/SSD hard drive). The computer program does not necessarily have to be stored on such a computer-readable storage medium in order to be made available to the motor vehicle, but can also be obtained via the Internet or from other external sources. What has been described above with reference to the methods, the system, the computer program, and the vehicle also applies analogously to the computer-readable medium, and vice versa.

The disclosure also comprises the combinations of the features of the described embodiments. The disclosure therefore also comprises implementations which each have a combination of the features of several of the described embodiments, provided the embodiments have not been described as mutually exclusive.

In the following, exemplary embodiments of the disclosure are described.

The exemplary embodiments described below are example embodiments of the disclosure. In the exemplary embodiments, the described components of the embodiments each represent individual features of the disclosure that are to be considered independently of one another, each also further developing the disclosure independently of one another. For this reason, the disclosure is also intended to include other combinations of the features of the embodiments than those described. Additionally, the described embodiments can also be complemented by additional, already described features of the disclosure.

In the figures, the same reference signs refer to functionally similar elements.

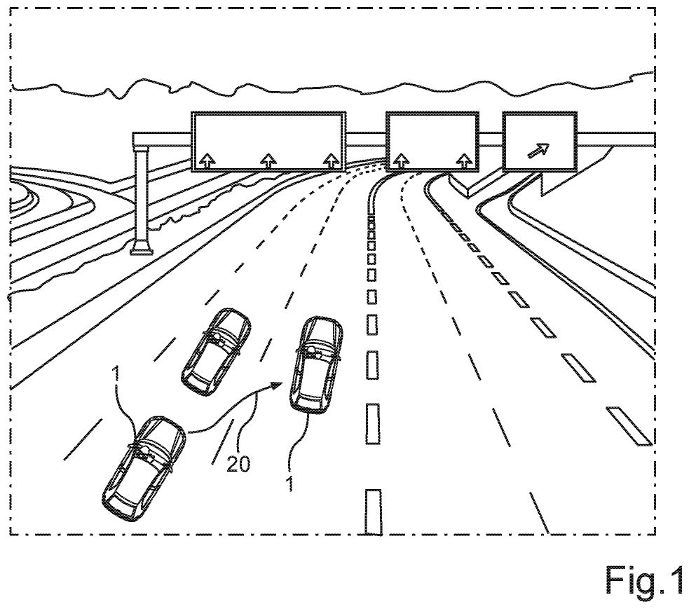

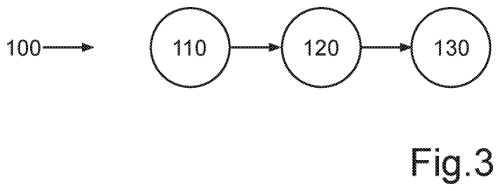

FIG. 1 schematically shows a motor vehicle 1 in a road portion to be traveled, carrying out an embodiment of the method 100, shown in FIG. 3, according to the disclosure. FIG. 1 shows a schematic representation of the vehicle 1 on a multi-lane road. The road comprises a plurality of lanes, which can have different risk levels. The lane attributes may be determined based upon infrastructure information that takes into account static and dynamic factors.

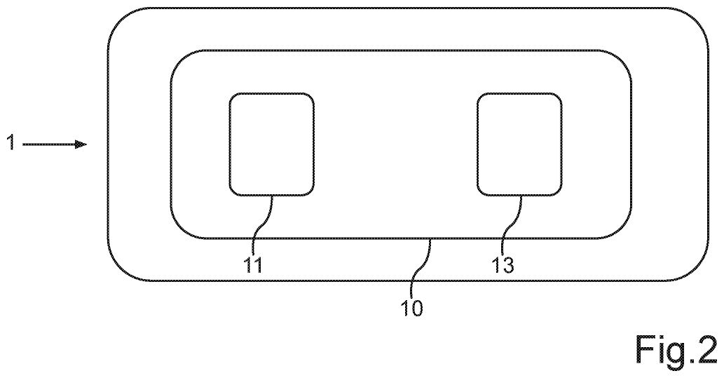

The vehicle 1 is equipped with a system 10, shown in FIG. 2, which may comprise a first acquisition unit 11 and a processing unit 13. The first acquisition unit 11 may acquire map information about the infrastructure features of the drivable lanes of the road portion. This information may comprise, among other things, the number of lanes, the type of lanes, the presence and position of breakdown lanes, as well as road markings and traffic signs.

In an alternative embodiment of the system 10, a second acquisition unit can be provided. Furthermore, it can be provided that only one acquisition unit be provided. The one provided acquisition unit can execute the steps, in particular the method steps, of the acquisition unit 11 and/or of the second acquisition unit. In the alternative embodiment, the second acquisition unit additionally acquires traffic data for the current road portion. The traffic data may include the current position of vehicle 1, the traffic density on the individual lanes, available time gaps for a lane change, and the speed and direction of movement of adjacent vehicles.

The processing unit 13 may determine attributes for the lanes based upon the acquired map information. Based upon these attributes, an emergency route 20 may be calculated that specifies an optimal movement of the vehicle 1 in order to perform a minimal risk maneuver (MRM). Additionally, the processing unit 13 may determine the attributes for the lanes based upon the acquired traffic data. These attributes are adapted depending upon the current traffic data in order to carry out a situation-appropriate risk assessment. The emergency route 20 can then be calculated.

In FIG. 1, the vehicle 1 may be positioned in a lane with a medium risk value. The emergency route 20 shows a movement of the vehicle 1 toward a safer lane with a lower risk value. The emergency route 20 may be continuously adapted in real time, based upon the remaining travel time until a safe stopping point is reached and the current traffic situation.

A lane change can be performed if the traffic data identify a lane with a lower risk score. Alternatively, a braking strategy can be applied to slow down the vehicle 1 within an area rated as safe of the calculated emergency route 20.

The system 10 may be designed to use traffic data from the environment surrounding vehicle 1, including camera data, radar data, and LIDAR data. The map information can be updated at intervals using fleet data to enable the most precise and up-to-date calculation of the emergency route 20.

FIG. 1 also shows a vehicle driving in front of vehicle 1. This vehicle can be within the same lane or in an adjacent lane. The second acquisition unit may recognizes the vehicle in front and ascertains its movement. Based upon this information, the system 10 can perform a risk analysis to decide whether a lane change or braking strategy is necessary.

The processing unit 13 determines attributes for the lanes and adapts them in real time. If the vehicle ahead slows down or brakes unexpectedly, the system 10 can decide whether the vehicle 1 should accelerate, brake, or initiate a lane change. The attributes may be adapted taking into account the calculated emergency route 20. The attributes of the adjacent lanes can be adapted depending upon a detected fault severity. The fault severity of a predefined class can be assigned from a plurality of fault classes.

The emergency route 20 is calculated such that the vehicle 1 executes a safe movement. If the current lane is blocked or unsafe, a change to an adjacent lane with a lower risk value may be considered. Alternatively, the vehicle 1 can be slowed down in order to reach a safe stopping position.

The vehicle driving in front of vehicle 1 thus influences the continuous adaptation of the emergency route 20. If vehicle 1 is in a minimal risk maneuver (MRM), it is checked whether stopping within the current lane or changing lanes is the safer option. The system can use camera data, radar data, and/or LIDAR data to perform a more precise environmental analysis.

By evaluating traffic data in real time, the system 10 can react faster in critical situations and minimize the risk of a rear-end collision.

FIG. 2 shows a schematic representation of the system 10 according to an embodiment which may be integrated into the vehicle 1 and is designed to determine the emergency route 20 for an automated driving function. The system 10 comprises a first acquisition unit 11 and a processing unit 13. In another embodiment, the second acquisition unit 12 can be provided.

The first data acquisition unit 11 may be designed to acquire map information with infrastructure features of drivable lanes of a road portion. This includes information such as the number and type of lanes, the presence and position of breakdown lanes, road markings, and traffic signs. These static data allow the system to make an initial assessment of the street environment.

The second acquisition unit may be designed to detect traffic data for the road portion to be traveled. This data may comprise the position of the vehicle 1, the traffic density on the lanes, available time gaps for lane changes, and the speed and direction of movement of adjacent vehicles. The acquired traffic data enable a dynamic adaptation of the previously determined lane attributes.

The processing unit 13 may be configured to analyze the map information acquired by the first acquisition unit 11 and to determine attributes for the lanes therefrom. These attributes can comprise, for example, the average speed of a lane or the accessibility of a safe stopping position.

In the alternative configuration, the processing unit 13 may adapt the attributes depending upon the traffic data acquired by the second acquisition unit in order to perform a situation-dependent risk assessment.

Based upon these attributes, the processing unit 13 may calculate an emergency route 20. The emergency route 20 may specify the optimal movement of vehicle 1 and/or an optimal stopping point to minimize the risk during a minimal risk maneuver (MRM). The environment may be continuously analyzed so that the vehicle 1 can either change lanes or reach a safe stopping position within a defined area.

The system 10 may be designed to fully execute the method 100 for determining an emergency route 20 with reference to FIG. 3. The vehicle 1 is equipped with the system 10 and can automatically execute the method 100 to perform an optimal MRM.

FIG. 3 shows a schematic representation of the method 100 for determining an emergency route 20 for an automated driving function of the vehicle 1. The method 100 comprises a plurality of method steps.

The method 100 may begin with step 110, in which map information with infrastructure features of the drivable lanes of a road portion to be traveled may be acquired. This information may comprise, among other things, the number and type of lanes, the presence and position of breakdown lanes, road markings, and traffic signs. Acquiring this static data may enable an initial analysis of the environment.

In step 120, attributes for the lanes may be determined based upon the acquired map information. These attributes may comprise, for example, the average speed of a lane or its suitability as a potential stopping position. The lanes may be assessed with regard to their risk potential in order to create a basis for later decisions.

In step 130, an emergency route 20 may be ascertained based upon the determined attributes of the lanes. The emergency route 20 may specify the optimal movement of the vehicle 1 in order to carry out a minimal risk maneuver (MRM) and in particular in order to reach an optimal stopping point. The vehicle 1 can either change lanes or use a braking strategy to reach a safe stopping position.

The method 100 may be executed continuously, so that the emergency route 20 can be adapted in real time. This enables adaptive control of the vehicle 1, taking into account both static and dynamic factors.

Additionally, the method can further comprise a method step in which traffic data for the road portion to be traveled may be acquired. This data may comprise the current position of vehicle 1, the traffic density on the individual lanes, available time gaps for lane changes, and the speed and direction of movement of adjacent vehicles. By acquiring this dynamic information, the method 100 can take the current traffic situation into account in real time.

In a further supplementary step, the previously determined attributes of the lanes can be adapted to the current traffic data. If the traffic situation changes-for example due to high traffic density or temporary obstacles such as construction sites-the lane attributes may be modified accordingly. This ensures that the risk assessment of the lanes is always up to date.

Ascertaining the emergency route 20 can additionally be done based upon the determined attributes of the drivable lanes and the acquired traffic data.

Overall, the examples show how a method for forming an emergency route for an automated driving function can be provided.

1.-15. (canceled)

16. A method for determining an emergency route for an automated driving function of a vehicle, the method comprising:
acquiring map information associated with infrastructure features of drivable lanes of a road to be traveled;
determining attributes of the drivable lanes based on the acquired map information; and
determining the emergency route for the automated driving function of the vehicle based on the determined attributes of the drivable lanes.

17. The method according to claim 16, further comprising:
acquiring traffic data associated with the road to be traveled;
updating the attributes of the drivable lanes based on the acquired traffic data;
updating the emergency route based on the updated attributes;
updating the emergency route in real-time based on a transition demand (TD) and a minimal risk maneuver (MRM); and
providing control instructions to control the vehicle based on the updated emergency route, wherein a set of the attributes associated with lanes of the drivable lanes adjacent to the vehicle are updated based on a fault severity, and wherein the fault severity is assigned to a predefined class of a plurality of fault classes.

18. The method according to claim 17, wherein the updating the emergency route in real-time is based on remaining travel time until reaching the MRM.

19. The method according to claim 17, further comprising:
identifying, using the traffic data, one lane of the drivable lanes with an associated lower risk value than a currently traveled lane, wherein the control instructions comprise a braking strategy in order to brake the vehicle in a zone rated as safe within the emergency route; and
based on the identifying the one lane with the associated lower risk value than the currently traveled lane, providing further control instructions that include a lane change.

20. The method according to claim 17, further comprising:
determining a risk assessment score based on the infrastructure features and the traffic data, wherein the updating the attributes of the drivable lanes is based on the risk assessment score.

21. The method according to claim 20, wherein the updating the attributes of the drivable lanes comprises:
determining a stopping position of the emergency route based on the risk assessment score.

22. The method according to claim 17, wherein the traffic data comprises at least one of a current position of the vehicle, traffic density associated with the drivable lanes, available time gaps for lane changes, a speed associated with vehicles adjacent to the vehicle, a direction of movement of the vehicles adjacent to the vehicle, or a combination thereof.

23. The method according to claim 16, wherein the determining the emergency route comprises:
weighting a set of static attributes and a set of dynamic attributes based on a fault of the vehicle, wherein the attributes comprise the set of static attributes and the set of dynamic attributes,
wherein the determining the emergency route is based on the weighting.

24. The method according to claim 17, wherein traffic data comprises at least one of camera data, radar data, light detection and ranging (LIDAR) data, or a combination thereof, and wherein the updating the emergency route in real-time is based on the traffic data.

25. The method according to claim 16, wherein the map information comprises at least one of a number of lanes, a type of the drivable lanes, an availability of breakdown lanes of the drivable lanes, a position of the breakdown lanes, road markings, traffic signs, traffic control system, or a combination thereof.

26. The method according to claim 16, wherein the attributes comprise a value for an average speed of one drivable lane of the drivable lanes, and wherein the attributes are updated in real-time based on temporary changes of the infrastructure features.

27. The method according to claim 16, wherein the emergency route is determined such that the vehicle reaches a stopping position within a defined time window.

28. A system for determining an emergency route for an automated driving function of a vehicle, comprising:
an acquisition unit configured to acquire map information associated with infrastructure features of drivable lanes of a road to be traveled, and
a processing unit configured to:
determine attributes for the drivable lanes based on the acquired map information; and
determine the emergency route for the automated driving function of the vehicle based on the determined attributes of the drivable lanes.

29. The system of claim 28, wherein a vehicle is coupled to the acquisition unit and the processing unit.

30. One or more tangible, non-transitory computer-readable media comprising instructions that, when executed by at least one computing device, causes the at least one computing device to perform operations comprising:
acquiring map information associated with infrastructure features of drivable lanes of a road to be traveled;
determining attributes of the drivable lanes based on the acquired map information; and
determining the emergency route for the automated driving function of the vehicle based on the determined attributes of the drivable lanes.
